(19) United States
(12) Patent Application Publication
(10) Pub. No.: US 2007/0120994 A1
(43) Pub. Date: May 31, 2007

(54) Solid-state imaging device

(75) Inventor: Toshiaki Hayakawa, Kurokawa-gun (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/603,165

(22) Filed: Nov. 22, 2006

(30) Foreign Application Priority Data
Nov. 24, 2005 (JP) P2005-338938

(51) Int. Cl. H04N 5/335

(52) U.S. Cl. 348/311

(57) ABSTRACT

A solid-state imaging device is provided. A horizontal transfer section in the solid-image device is divided into at least three blocks each including a horizontal transfer path transferring electric charge, which is transferred through vertical transfer paths, in a row direction perpendicular to the column direction. The at least three blocks includes an intermediate block other than the blocks at each end in the row direction of horizontal transfer section, an output portion corresponding to the intermediate block is connected to first end portion of the last stage of storage areas in the intermediate block, the first end portion being placed opposite to a second end portion facing to the vertical transfer paths in the column direction of the last stage of the storages areas.

### BACKGROUND OF THE INVENTION

1. Field of the Invention

The present invention relates to a CCD (charge coupled device) type solid-state imaging device.

2. Description of Related Art

With recent increase in the number of pixels of the CCD-type solid-state imaging device, the drive frequency of each horizontal CCD thereof has increased. This has caused increase in the electric power consumption of the CCD-type solid-state imaging device. Hitherto, a CCD-type solid-state imaging device configured to have no horizontal CCDs has been proposed to suppress the power consumption thereof (see, for example, JP-A-2002-152597). According to the solid-state imaging device described in JP-A-2002-152597, the power consumption can considerably be reduced, because the solid-state imaging device has no horizontal CCDs. However, flexible drive measures, such as addition of pixels in a horizontal direction, to enhance picture quality cannot be achieved, because no horizontal CCDs are provided in the solid-state imaging device.

Meanwhile, devices described in JP-A-2004-80286 and JP-A-2004-194023 are examples of solid-state imaging devices that have a horizontal CCD and are enabled to achieve low power consumption. Each of solid-state imaging devices described in JP-A-2004-80286 and JP-A-2004-194023 is configured so that the horizontal CCD is divided into two horizontal CCD elements, and that an output amplifier is connected to each of the two horizontal CCD elements.

However, it is difficult to deal with increase in the power consumption due to increase in the number of pixels in the solid-state imaging device only by dividing a horizontal CCD into two elements as described in JP-A-2004-80286 and JP-A-2004-194023. Additionally, it is necessary to devise the structure of the horizontal CCD in the configuration of the imaging device, which is described in JP-A-2004-80286. In a case where the miniaturization of the imaging device is advanced by increasing the number of pixels thereof, it is difficult to design the imaging device.

### SUMMARY OF THE INVENTION

An object of an illustrative, non-limiting embodiment of the invention is to provide a solid-state imaging device, the power consumption of which is low and which is easy to be designed.

According to one aspect of the invention, there is provided a CCD-type solid-state imaging device including: a plurality of photoelectric conversion elements; a plurality of vertical transfer paths, each transferring electric charge, which is read from the photoelectric conversion elements, in a column direction; a horizontal transfer section including at least three blocks, wherein each of the at least three blocks includes a horizontal transfer path transferring the electric charge, which is transferred through the vertical transfer paths, in a row direction perpendicular to the column direction; and output sections corresponding to the at least three blocks, each of the output sections outputting a signal in accordance with the electric charge transferred in corresponding one of the at least three blocks. The horizontal transfer path includes storage areas, and when the electric charge is transferred through the horizontal transfer path, the electric charge is stored in the storage areas sequentially from the first stage to the last stage of the storage areas, and the at least three blocks includes an intermediate block other than the blocks at each end in the row direction of horizontal transfer section, an output portion corresponding to the intermediate block is connected to first end portion of the last stage of the storage areas in the intermediate block, the first end portion being placed opposite to a second end portion facing to the vertical transfer paths in the column direction of the last stage of the storages areas.

In one aspect of the invention, each of the output portions corresponding to the at least three blocks may be connected to a first end portion of the last stage of the storage areas in corresponding one of the at least three blocks, the first end portion being placed opposite to a second end portion facing to the vertical transfer paths in the column direction of the last stage of the storages areas.

In one aspect of the invention, when a voltage is applied to the last stage of the storage areas, the last stage can have such a potential to become deeper from the second end portion toward the first end portion in the column direction.

In one aspect of the invention, the storage areas other than the last stage of the storage areas can have such a width in the row direction to become smaller away from the vertical transfer paths, and the last stage has such a wide in the row direction to become larger away from the vertical transfer paths.

### BRIEF DESCRIPTION OF THE DRAWINGS

The features of the invention will appear more fully upon consideration of the exemplary embodiments of the inventions, which are schematically set forth in the drawings, in which:

FIG. 1 is a schematic plan view illustrating a part of a CCD-type solid-state imaging device, which is an exemplary embodiment according to the invention, by removing stacked materials on a semiconductor substrate; and

FIG. 2 is an enlarged view of a part of 1 block of a HCCD shown in FIG. 1.

### DETAILED DESCRIPTION OF THE EXEMPLARY EMBODIMENTS

Although the invention will be described below with reference to the exemplary embodiment thereof, the following exemplary embodiment and its modification do not restrict the invention.

According to an exemplary embodiment of the invention, a solid-state imaging device, the power consumption of which is low and which is easy to be designed, can be provided.

Hereinafter, an exemplary embodiment of the invention is described with reference to the accompanying drawings.

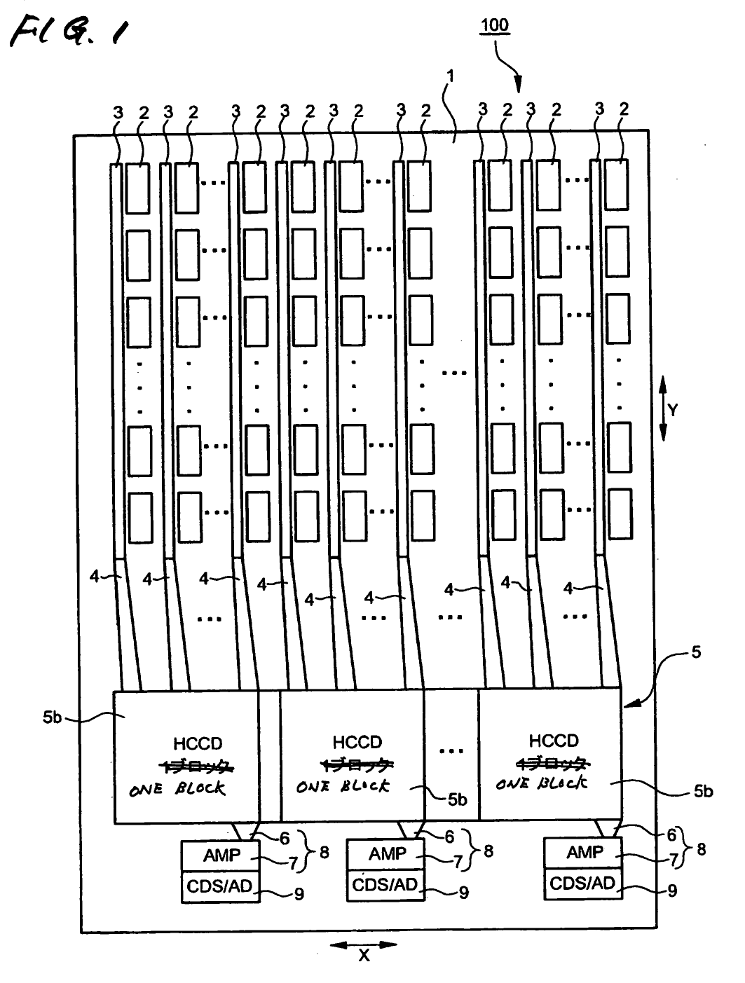

FIG. 1 is a schematic plan view illustrating a part of a CCD-type solid-state imaging device, which is an exemplary embodiment according to the invention, by removing stacked materials on a semiconductor substrate.

A solid-state imaging device 100 shown in FIG. 1 has a plurality of photoelectric conversion elements 2 arranged on an n-type semiconductor substrate 1 like a square lattice that has rows extending in X-direction and columns extending in Y-direction perpendicular to the rows, as viewed in FIG. 1. The solid-state imaging device 100 also has a plurality of vertical transfer channels (VCCDs) 3 adapted to transfer electric charge, which is read from each of the photoelectric conversion elements 2, in the column direction, lines memories (LMs) 4 each being connected to the vertical transfer channels 3 and adapted to temporarily store electric charge transferred through the vertical transfer channels 3, and a horizontal transfer channel (HCCD) 5 adapted to read electric charge stored in the LM 4 and to transfer the read electric charge in the row direction. The VCCDs 3 correspond to the vertical transfer paths, while the HCCD 5 corresponds to the horizontal transfer section.

The HCCD 5 is divided into at least three blocks in the row direction. For example, eight VCCDs 3 arranged in the row direction are electrically connected to each of the blocks 5b. It is sufficient that the number of the VCCDs 3 is two or more. An output portion 8 is connected to each of the blocks 5b and is adapted to output a signal corresponding to electric charge having been transferred to the last stage of the HCCD 5 of corresponding one of the blocks 5b. Also, a CDS/AD portion 9 is connected to each of the output portions 8. The CDS/AD portion 9 is adapted to perform analog signal processing, that is, correlated double sampling on an analog signal outputted from corresponding one of the output portions 8 and to digitalize the processed analog signal.

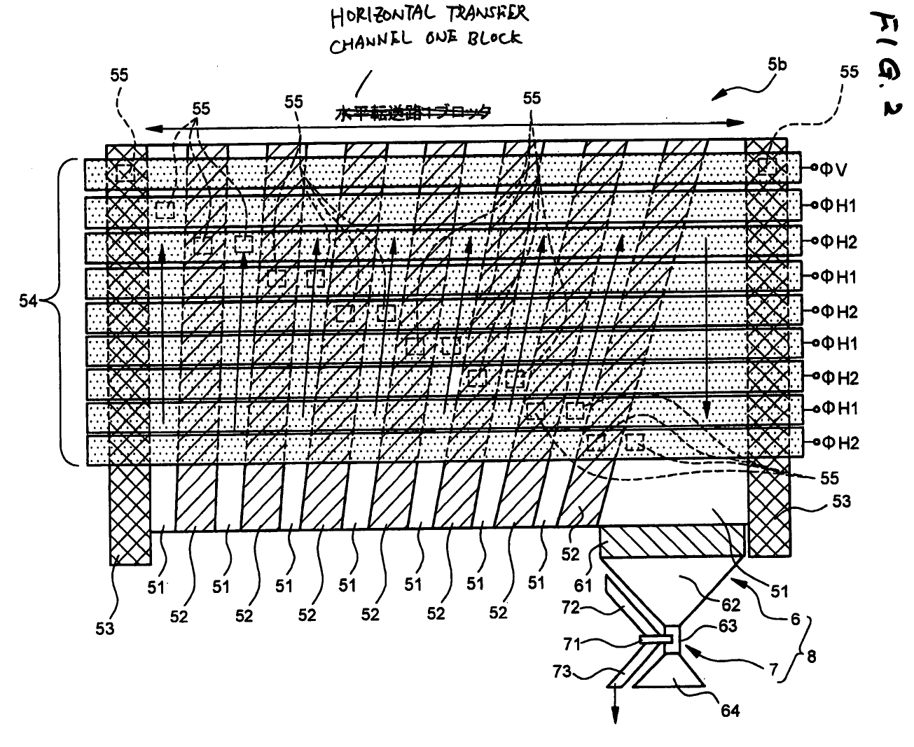

FIG. 2 is an enlarged view of a part of 1 block of the HCCD 5 shown in FIG. 1. FIG. 2 partly shows stacked materials on a part of the semiconductor substrate, which corresponds to the block 5b.

As shown in FIG. 2, a part of the HCCD 5 provided in the block 5b includes storage areas 51, each of which serves as an area adapted to store electric charge when a charge transfer operation is performed and which is made of n-type impurities, and also includes barrier areas 52, each of which serves as an area constituting a barrier when the HCCD 5 performs a charge transfer operation, and which is made of n-type impurities. The storage area 51 and the barrier area 52 are alternately placed in the row direction. The LM 4 shown in FIG. 1 is connected to each of the storage areas 51. Although not shown in FIG. 2, a storage electrode having the same shape as that of the storage area 51 is formed above each of the storage areas 51. Also, a barrier electrode having the same shape as the barrier area 52 is formed above each of the barrier areas 52.

Interblock barrier areas 53, which are adapted to separate the blocks 5b from each other and are made of n-type impurities, are formed at parts of the HCCD 5, which are respectively placed at both ends in the row direction of the block 5b. Although not shown in FIG. 2, an interblock barrier electrode having the same shape as that of the interblock barrier area 53 is formed above the interblock barrier area 53.

Wires 54 made of tungsten are formed above the storage electrode, the barrier electrode, and the interblock barrier electrode. A light shielding film (not shown) made of aluminum is formed above each of the wires 54. The storage electrode, the barrier electrode, and the interblock barrier electrode are connected to the wires 54 at contact portions, respectively.

Electric charge having been transferred to each of the storage areas 51 from the LMs 4 can be transferred in the row direction by controlling a voltage supplied to each of the storage electrodes, the barrier electrodes, and the interblock barrier electrodes through the wires 54. It is now assumed that electric charge is transferred from the left to the right on paper on which FIG. 2 is drawn, that the storage area 51 provided at the leftmost end is defined as a first stage storage area 51, as viewed in FIG. 2, and that the storage area 51 provided at the rightmost end is defined as the last stage storage area 51, as viewed in FIG. 2.

A drive pulse φH1 is supplied to the wires 54 connected to the storage electrodes provided above odd stage storage areas 51 and to the barrier electrodes provided above even stage barrier areas 52. Also, a drive pulse φH2 is supplied to the wires 54 connected to the storage electrodes provided above even stage storage areas 51 and to the barrier electrodes provided above odd stage barrier areas 52. A drive pulse φV is supplied to the wire 54 connected to the interblock barrier electrode. Thus, a part of the HCCD 5, which corresponds to each of the blocks 5b, is two-phase-driven.

When the HCCD 5 stars electric charge transfer, the signal level of the drive pulse φH1 is at a high level. Also, the signal level of the drive pulse φH2 is at a low level, and that of the drive pulse φV is at a low level. Then, after electric charge is transferred from the LM 4 to the storage area 51, the signal level of the drive pulse φH1 is at a low level, and the signal level of the drive pulse φH2 is at a high level. Subsequently, a drive operation is performed so that the signal level of the drive pulse φH1 is changed to a high level, and that the signal level of the drive pulse φH2 is changed to a low level. Thus, such drive operations are repeatedly performed. Consequently, electric charge is sequentially moved to the next stage storage area 51. Finally, the electric charge is transferred to the last stage storage area 51.

The output portion 8 is connected to one of the end portions, which is located opposite to the VCCDs 3, in the column direction of the last stage storage area 51. That is, the output portion 8 is connected to the end portion of the last stage storage area 51, which is not connected to the LM 4.

Each of the output portions 8 includes an output gate portion 6 and an amplifying portion 7.

The output gate portion 6 includes an output gate barrier area 61, which is connected to the last stage storage area 51 and is made of n-type impurities, and a charge storage area 62 connected to the output gate barrier area 61, a floating diffusion (FD) area 63 connected to the charge storage area 62, and a reset gate 64 adapted to reset electric potential of the FD area 63. Although not shown, electrodes are formed above the output gate barrier area 61 and the charge storage area 62, respectively, to apply voltages to the areas. The electric charge transferred to the last stage storage area 51 is moved to and is stored in the charge storage area 62 by deepening the potential of the output gate barrier area 61. Then, the electric charge stored in the storage area 62 is moved to and is stored in the FD area 63.

The amplifier portion 7 is constituted by including a source follower circuit. A first stage MOS transistor of this source follower circuit is constituted by including a gate electrode 71, a source area 72, and a drain area 73 connected to the FD area 63. A change in the potential of the FD area 63 is converted by the first stage MOS transistor into a signal. This signal is amplified by the source follower circuit. Then, the amplified signal is inputted to the CDS/AD portion 9. The configuration of the output portion 8 is not limited to that shown in FIG. 2. Various known configurations may be utilized as the configuration of the output portion 8.

With such a configuration, electric charge having been transferred to the last stage storage area 51 is transferred in the column direction from one of the end portions of the storage area 51 to the FD area 63. Then, the electric charge is stored in the FD area 63. Thus, a voltage signal corresponding to the electric charge stored in the FD area 63 can be obtained.

The solid-state imaging device according to the present embodiment is configured so that the electric charge transferred to the last stage storage area 51 in each of the blocks 5b is transferred in the column direction and is stored in the charge storage area 62. Thus, time taken to perform the charge transfer in the column direction from the last stage storage area 51 to the charge storage area 62 is longer than time taken to perform charge transfer in the row direction from the storage area 51 to the next stage storage area 51. Consequently, there is a fear of reduction in charge transfer efficiency in the block 5b.

Thus, the solid-state imaging device according to the present embodiment is adapted so that the potential of the last stage storage area 51 in the each of the blocks 5b at the application of the voltage is made to be deeper from one of the end portions in the column direction of the last stage storage area 51, which is at the side of the VCCDs 3 toward the opposite end portion in the column direction of the last stage storage area 51. Consequently, time taken to achieve the charge transfer in the column direction from the last stage storage area 51 to the charge storage area 62 can be shortened. Thus, the charge transfer efficiency of the entire block 5b can be enhanced.

A method of changing the width in the row direction of the last stage storage area 51 is simple in manufacturing the device, as a method of ramping the potential of the last stage storage area 51 at the application of the voltage. Therefore, the method of changing the width is employed by the present embodiment. That is, the potential of the last stage storage area 51 at the application of the voltage is ramped by configuring the device so that as shown in FIG. 2, the width in the row direction of each of the storage areas 51 other than the last stage storage area 51 becomes narrower toward the side opposite to the VCCDs 3, while the width in the row direction of the last stage storage area 51 becomes wider toward the side opposite to the VCCDs 3 by an amount of reduction in the width in the row direction of the storage areas 51 other than the last stage storage area 51. Although it is not indispensable to change the widths of the storage areas 51 other than the last stage storage area 51, it is advantageous in designing to make the width of the storage areas 51 other than the last stage storage area 51 narrower toward the side opposite to the VCCDs 3 so as to form the last stage storage area 51 into a shape shown in FIG. 2. Incidentally, an arrow indicating the direction of ramping the potential is shown corresponding to each of the storage areas 51 in FIG. 2. The potential of each of the storage areas 51 becomes deeper toward the direction of the corresponding arrow.

In addition to the method illustrated in FIG. 2, the following methods may be employed as the method of ramping the potential of the last stage storage area 51 at the application of the voltage. That is, one of such methods is to set the width in the row direction of the last stage storage area 51 at a constant value, and to change the impurity concentration of the last stage storage area 51 according to the distance from the VCCD 3. Another method is to set the width in the row direction of the last stage storage area 51 at a constant value, and to change the thickness of the last stage storage area 51 according to the distance from the VCCD 3.

As above described, the solid-state imaging device according to the present embodiment is configured so that the HCCD 5 is divided into at least three blocks 5b, and that each of the blocks 5b is provided with the output portion 8. Thus, as compared with the case where the HCCD 5 is not divided, the present embodiment can considerably reduce the drive frequency of the HCCD 5. Consider, for example, a case where the number of the storage areas 51 included in the HCCD 5 is 2048. In this case, it is assumed that when the HCCD 5 is driven without being divided, a drive frequency of 36 MHz is required to achieve a certain frame rate. In the case where the HCCD 5 is divided into two parts, as described in Patent Documents 2 and 3, the drive frequency required to achieve the certain frame rate is 36 MHz/2=18 MHz. Additionally, in a case where the HCCD 5 is divided into three parts or more (for example, 256 parts), similarly to the present embodiment, the drive frequency required to achieve the certain frame rate is 36 MHz/256≈140 KHz. Thus, as the division number for the HCCD is increased, the drive frequency can be reduced. Consequently, the power consumption can be reduced for that.

Also, according to the solid-state imaging device of the present embodiment, the drive frequency of the HCCD 5 can be reduced. Thus, there is no need for selecting a low-resistance material as the material of the wires 54 shown in FIG. 2. Consequently, process rules can be alleviated.

Preferably, the division number for the HCCD 5 is large. However, in a case where the division number is too large, the area of a space required to install the output portion 8 and the CSD/AD portion 9 is reduced to a small value, so that the process rule becomes stringent, and that the cost is increased. Thus, preferably, the division number is set at a value determined by taking the balance between the power consumption and the cost of the solid-state imaging device into account. Incidentally, in one block 5b, it is necessary to transfer electric charge in the row direction. Thus, it is necessary that at least two storage areas 51 are included in one block 5b.

In a case where the HCCD 5 is divided into 3 blocks or more, similarly to the present embodiment, it is important what part of each block the output portion 8 is connected to. In the case where the HCCD is divided into 2 blocks, nothing adjoins one of ends in the row direction of each of two blocks. Thus, it is easy to connect the output portion to this end in the row direction of each of the blocks.

However, in the case where the HCCD is divided into, for example, 3 blocks, both ends of the central block adjoin the other blocks, respectively. Thus, it is necessary to devise a method of connecting the output portions to the blocks. The HCCD can be bent, similarly to the configuration described in Patent Document 2. However, according to this configuration, the gap between the blocks obtained by the division is broadened. Therefore, the HCCD of this related imaging device has a problem in that this HCCD cannot deal with further increase in the number of pixels thereof and with further miniaturization thereof. Also, the HCCD of this related imaging device largely differs in configuration from conventional common HCCDs. Thus, the related imaging device has a problem in that large-scale design change is needed.

The solid-state imaging device according to the present embodiment is configured so that the output portion 8 is connected to the end portion in the column direction of the last stage storage area 51 of each of the blocks 5b, which is not connected to the LM 4, between the end portions in the column direction of the last stage storage area 51. Thus, the gap between the blocks 5b can be suppressed to a minimum value. Additionally, the present embodiment can deal with further increase in the number of pixels thereof and with further miniaturization thereof. Also, because the HCCD 5 is not largely different in configuration from the conventional common HCCDs, the solid-state imaging devices according to the invention can be manufactured without large design change.

In the solid-state imaging device according to the present embodiment, the potential of the last stage storage area 51 upon application of a voltage is ramped. This can eliminate the fear of reduction in the charge transfer efficiency, which is caused by connecting the output portion 8 to the end portion in the column direction of the last stage storage area 51 of each of the blocks 5b, which is not connected to the LM 4, between the end portions in the column direction of the last stage storage area 51.

The solid-state imaging device according to the present embodiment has the HCCD 5. Thus, electric charge mixing can be performed in each of the blocks 5b. Consequently, high sensitivity can be obtained.

In the foregoing description, it has been described that the potential of the last stage storage area 51 of each of the blocks 5b can be ramped. However, in a case where less significance is placed on the charge transfer efficiency, it is unnecessary to ramp the potential of the last stage storage area 51.

Also, in the foregoing description, it has been described that the photoelectric conversion elements 2 are arranged like a square lattice. However, various known arrangements can be applied to the arrangement of the photoelectric conversion elements 2. As disclosed in, for example, JP-A-10-136391, the VCCD may is configured to meander.

Also, in the foregoing description, it has been described that the output portion 8 is connected to the end portion in the column direction of the last stage storage area 51 in each of all the blocks 5b. However, the output portion 8 may be connected to another position of each of the blocks 5b (that is, the leftmost block 5b and the rightmost block 5b, as viewed in FIG. 1) placed at both ends in the row direction among all the blocks 5b.

For example, it is assumed that the leftmost block 5b transfers electric charge from the right to the left, as viewed in FIG. 1, and that the rightmost block 5b transfers electric charge from the left to the right, as viewed in FIG. 1. Additionally, the output portion 8 is connected to the end portion in the row direction of the last stage storage area 51 in the leftmost block 5b, as viewed in FIG. 1. Also, the output portion 8 is connected to the end portion in the row direction of the last stage storage area 51 in the rightmost block 5b, as viewed in FIG. 1. There is a space around the end portion in the row direction of the last stage storage area 51 of each of the blocks 5b respectively placed at both the leftmost side and the rightmost side of all the blocks 5b. Thus, the imaging device according to the present embodiment can have such a configuration. In a case where the present embodiment has such a configuration, it is unnecessary to ramp the potential of each of the storage areas 51 upon application of the voltage, which are provided in each of the blocks 5b that are placed at both the leftmost side and the rightmost side of all the blocks 5b, respectively.

Incidentally, the imaging device according to the invention may be configured so that the output portion 8 is connected to an end portion in the column direction of the last stage storage area 51 in each of all the blocks 5b, as shown in FIG. 1. With this configuration, the imaging device according to the invention has an advantage in easily implementing the blocks 5b all of which have the same properties.

Additionally, in the foregoing description, it has been described that when the HCCD 5 is driven, the signal level of the drive pulse φV applied to the interblock barrier area 53 is fixedly set at the low level. The imaging device according to the invention may be adapted so that the level of the voltage applied to the barrier area 61 is fixedly set at the low level, and that the signal level of the drive pulse φV applied to the interblock barrier area 53 is controlled to change between the high level and the low level in synchronization with the drive pulses φH1 and φH2. Consequently, electric charge transferred to the last stage storage area 51 of the block 5b can be transferred to the adjacent block 5b, and also can be utilized for calibration of the amplifier included in the output portion 8.

While the invention has been described with reference to the exemplary embodiments, the technical scope of the invention is not restricted to the description of the exemplary embodiments. It is apparent to the skilled in the art that various changes or improvements can be made. It is apparent from the description of claims that the changed or improved configurations can also be included in the technical scope of the invention.

This application claims foreign priority from Japanese Patent Application No. 2005-338938, filed Nov. 24, 2005, the entire disclosure of which is herein incorporated by reference.

What is claimed is:

1. A solid-state imaging device comprising:
a plurality of photoelectric conversion elements;
a plurality of vertical transfer paths, each transferring electric charge, which is read from the photoelectric conversion elements, in a column direction;
a horizontal transfer section comprising at least three blocks, wherein each of the at least three blocks comprises a horizontal transfer path transferring the electric charge, which is transferred through the vertical transfer paths, in a row direction perpendicular to the column direction; and
output sections corresponding to the at least three blocks, each of the output sections outputting a signal in accordance with the electric charge transferred in corresponding one of the at least three blocks,
wherein
the horizontal transfer path comprises storage areas, and when the electric charge is transferred through the horizontal transfer path, the electric charge is stored in the storage areas sequentially from the first stage to the last stage of the storage areas, and
the at least three blocks includes an intermediate block other than the blocks at each end in the row direction of horizontal transfer section, an output portion corresponding to the intermediate block is connected to first end portion of the last stage of the storage areas in the intermediate block, the first end portion being placed opposite to a second end portion facing to the vertical transfer paths in the column direction of the last stage of the storages areas.

2. The solid-state imaging device according to claim 1, wherein each of the output portions corresponding to the at least three blocks is connected to a first end portion of the last stage of the storage areas in corresponding one of the at least three blocks, the first end portion being placed opposite to a second end portion facing to the vertical transfer paths in the column direction of the last stage of the storages areas.

3. The solid-state imaging device according to claim 1, wherein when a voltage is applied to the last stage of the storage areas, the last stage has such a potential to become deeper from the second end portion toward the first end portion in the column direction.

4. The solid-state imaging device according to claim 3, wherein the storage areas other than the last stage of the storage areas has such a width in the row direction to become smaller away from the vertical transfer paths, and the last stage has such a wide in the row direction to become larger away from the vertical transfer paths.

5. The solid-state imaging device according to claim 2, wherein when a voltage is applied to the last stage of the storage areas, the last stage has such a potential to become deeper from the second end portion toward the first end portion in the column direction.

6. The solid-state imaging device according to claim 5, wherein the storage areas other than the last stage of the storage areas has such a width in the row direction to become smaller away from the vertical transfer paths, and the last stage has such a wide in the row direction to become larger away from the vertical transfer paths.
